(19) United States
(12) Patent Application Publication
(10) Pub. No.: US 2006/0051148 A1
(43) Pub. Date: Mar. 9, 2006

(54) Electrically heated writing instrument

(76) Inventor: Vaughn Marquis, Madawaska, ME (US)

Correspondence Address: VAUGHN MARQUIS, 185 7TH AVE, MADAWASKA, ME, 04756, US

(21) Appl. No.: 10/934,942

(22) Filed: Sep. 3, 2004

(51) Int. Cl. B41J 29/28

(52) U.S. Cl. 400/18

(57) ABSTRACT

An electrically heated writing instrument comprising a hollow barrel including a conical end, a battery circuit housing including an electrical connecting means and at least one battery, a writing member, and a heating member or a heating cartridge including a heating member disposed about or within the hollow barrel. The writing instrument further includes a switching means coupled to said at least one battery and said heating member for controllably supplying power to the heating member and an end cap removably attached to said hollow barrel. In another embodiment there is disclosed an electrically heated writing instrument kit including a plurality of hollow barrels, a plurality of end caps, a plurality of pen covers, where each hollow barrel, end cap and pen cover comprises one of a plurality of colors, a heating cartridge, a plurality of writing members, each writing member including a writing medium comprising one of a plurality of colors, at least one battery, a switching means and a strap.

### FIELD OF INVENTION

The present invention relates to writing instruments and, more particularly to an electrically heated writing instrument.

### BACKGROUND OF THE INVENTION

Many conventional writing instruments include pencils, crayons, markers and chalk. A widely accepted writing instrument includes the conventional pen which comes in a variety of designs, colors and shapes and includes various writing mediums, such as, red, blue, black, green and glittering ink. Other examples of conventional writing instruments are writing instruments which include mechanical or fluid figurines, light emitting devices, games, vibrators and recording devices.

Conventional writing instruments, however, do not include a means to warm both the fingers of a user or the writing medium of the instrument when an individual's hands and the writing instrument are exposed to cold temperatures.

There are many occupations and activities which require the use of a writing instrument while being outdoors. Examples of such occupations include police officers, game wardens, delivery people, journalist, and mechanics. Examples of such activities include various sports, hobbies and school events. While outdoors, these individuals are often exposed to the cold elements resulting in a person's finger tips becoming cold or numb thereby making it difficult to hold and write with a writing instrument. In addition, the cold temperatures impact the physical properties of the writing instrument itself, affecting the viscosity of the writing medium and limiting the performance of the instrument.

Therefore there exists a need for an electrically heated writing instrument which not only warms the finger tips of a person when the person is holding and writing with the instrument but also warms the writing medium within the instrument, thus, facilitating writing in cold temperatures.

### SUMMARY OF THE INVENTION

Accordingly, it is the main object of the present invention to provide an electrically heated writing instrument for heating the finger tips of a person and facilitating the flow of a writing medium when the person and the writing instrument are exposed to cold temperatures.

It is also a further objective of the present invention to provide an electrically heated writing instrument which is easy to manufacture, repair and replace components and power sources.

It is a further objective of the present invention to provide an electrically heated writing instrument kit which allows an individual to interchange various components of the instrument, where each one of the components comprises one of a plurality of colors.

According to one aspect of the present invention, there is provided an electrically heated writing instrument comprising a hollow barrel including a conical end, and a battery circuit housing, said battery circuit housing including an electrical connecting means and at least one battery, a writing member including a writing tip, said writing member being disposed within said hollow barrel so that said writing tip extends outward from said conical end of said hollow barrel, a heating member disposed within or about said hollow barrel, a switching means coupled to said at least one battery and said heating member for controllably supplying power to said heating member, and an end cap removably attached to said hollow barrel.

Advantageously, the electrical connecting means includes a first receiver channel including a first channel contact, a second receiver channel including a second channel contact, a third receiver channel including a third channel contact, a first polarity end plate including a first contact arm, and a second polarity end plate including a second contact arm.

Preferably, the heating member is arranged in any one of being surroundably attached to an inner surface of said heating chamber, being surroundably attached to the exterior surface of said heating chamber, being formed within a sleeve, said sleeve being inserted within said heating chamber, or being molded or integrated within said heating chamber.

Advantageously, the switching means includes an electrical switch including any one of an on/off push button, a toggle switch, a dip switch, a variable resistance on/off switch, a thermostat, a timer control, a potentiometer, or a contact relay, said electrical switch including at least a first switch contact and a second switch contact.

Preferably, the end cap includes a bias member for securely holding said second polarity end plate, said electrical switch and said at least one battery within said battery circuit housing.

According to alternative embodiment of the present invention, there is provided an electrically heated writing instrument comprising: a hollow barrel including a conical end, a writing member including a writing tip, said writing member being disposed within said hollow barrel so that said writing tip extends outward from said conical end of said hollow barrel, a heating cartridge including a heating chamber having an aperture for receiving said writing member, a battery circuit housing including at least one battery, and an electrical connecting means, said heating cartridge being disposed within said hollow barrel wherein one end of the writing member enters the aperture of said heating cartridge, a heating member affixed within or about said heating chamber, a switching means electrically coupled to said at least one battery and said heating member for controllably supplying power to said heating member, and an end cap removably attached to said hollow barrel.

According to yet another embodiment of the present invention there is provided an electrically heated writing instrument kit comprising: a plurality of hollow barrels comprising one of a plurality of colors, and a plurality of end caps comprising one of plurality of colors, each one of said plurality of hollow barrels including a conical end; a plurality of writing members, each one of said plurality of writing members including a writing medium, said writing medium comprising one of a plurality of colors, each one of said plurality of writing members including a writing tip, one of said plurality of writing members being disposed within a corresponding one of said plurality of hollow barrels so that said writing tip of one said plurality of writing members extends outward from the conical end of said one of plurality of hollow barrels; a heating cartridge including a heating chamber having an aperture for receiving one of said plurality of writing members, a battery circuit housing including at least one battery and an electrical connecting means, said heating cartridge being disposed within one of said plurality of hollow barrels wherein an end of one of said plurality of writing members enters the aperture of said heating cartridge; a heating member affixed within or about said heating chamber; a switching means electrically coupled to said at least one battery and said heating member for controllably supplying power to said heating member; and one of said plurality of end caps removably attached to one of said plurality of hollow barrels.

Advantageously, each one of said plurality of end caps includes a protective cover including an extending shield member and a ring for coupling said writing instrument to a necklace, chain, bracelet, garment, or strap.

Preferably, the writing instrument includes a plurality of pen covers comprising one of a plurality of colors, each one of said plurality of pen covers being removably attached to a conical tip for covering the writing tip of one of said plurality writing members.

Advantageously, the writing instrument further includes a base and cover for covering said base, said base including a plurality of receptacles for receiving said plurality of hollow barrels comprising one of a plurality of colors, said plurality of end caps comprising one of a plurality of colors, said plurality of writing members including a writing medium comprising one of a plurality of colors, a plurality of pen covers comprising one of a plurality of colors, at least one power source, an electrical switch, a second polarity end cap, a heating cartridge and a strap.

### BRIEF DESCRIPTION OF THE DRAWINGS

FIG. 1 is an exploded view of the electrically heated writing instrument in accordance with a preferred embodiment of the present invention.

FIG. 2 is an exploded front view of the electrically heated writing instrument in accordance with a preferred embodiment of the present invention showing a writing medium disposed within a hollow barrel, a heating member, at least one battery disposed within a battery circuit housing, a second polarity end plate, an electrical switch, a bias member and an end cap.

FIG. 3A is a cross-sectional view of the battery circuit housing of the hollow barrel showing a first receiver channel, a second receiver channel, and a third receiver channel, each one of said receiver channels including a bias spring and base plate.

FIG. 3B is a cross-sectional view of the battery circuit housing of the hollow barrel showing a first receiver channel, a second receiver channel, and a third receiver channel, each one of said receiver channels including a female connector and a base plate.

FIG. 4A is a perspective view of the end cap including a lip and a protective cover which is opened, said protecting cover including an extending shield for receiving an operator member of an electrical switch.

FIG. 4B is a perspective view of the end cap including a protective cover which is closed such that the extending shield is placed over the operator member of an electrical switch.

FIG. 5 is an exploded view of the electrically heated writing instrument in accordance with an alternative embodiment of the present invention wherein the electrically heated writing instrument includes a heating cartridge including a heating chamber and battery circuit housing.

FIG. 6 is an exploded front view of the electrically heated writing instrument, showing a writing tip extended out from a conical member, a heating cartridge disposed within a hollow barrel and a battery circuit housing including at least one power source, polarity end plates, three receiver channels, an electrical switch, a bias member and an end cap.

FIG. 6A is a front view of an adaptor including a receptacle for receiving a variety of switching means, a first leg, a second leg and a polarity end plate.

FIG. 7 is a perspective view of an electrically heated writing instrument kit including a base including a plurality of receptacles for receiving a plurality of hollow barrels comprising one of a plurality of colors, a plurality of end caps comprising one of a plurality of colors, a plurality of writing members including a writing medium comprising one of a plurality of colors, a plurality of pen covers comprising one of a plurality of colors, at least one power source, an electrical switch, a second polarity end cap, a heating cartridge and a strap.

### DETAILED DESCRIPTION OF THE PREFERRED EMBODIMENTS

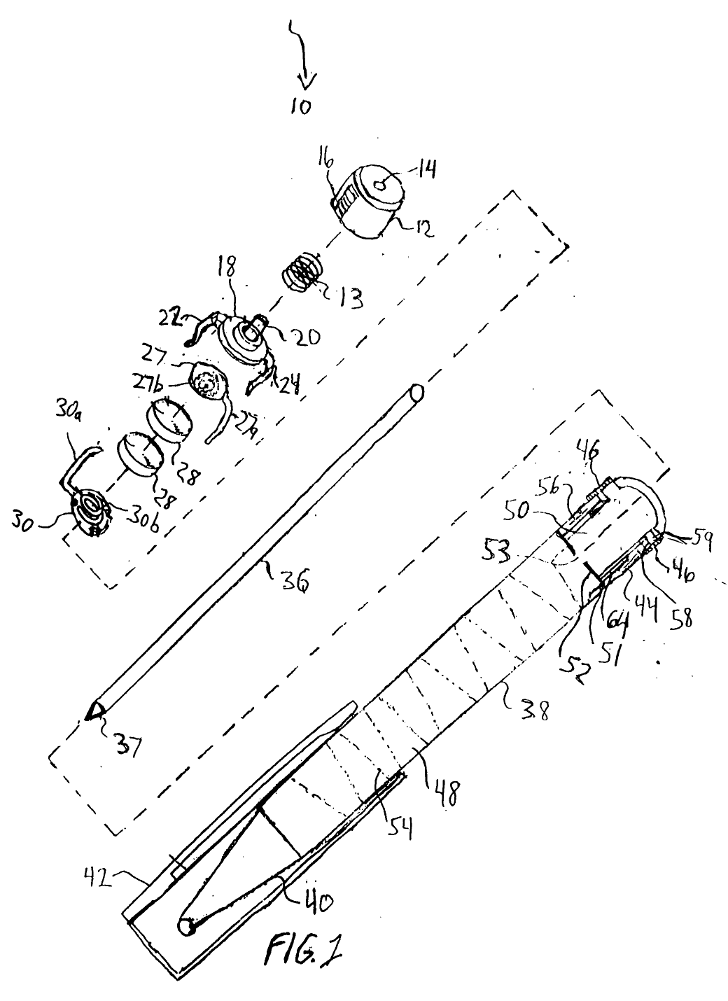

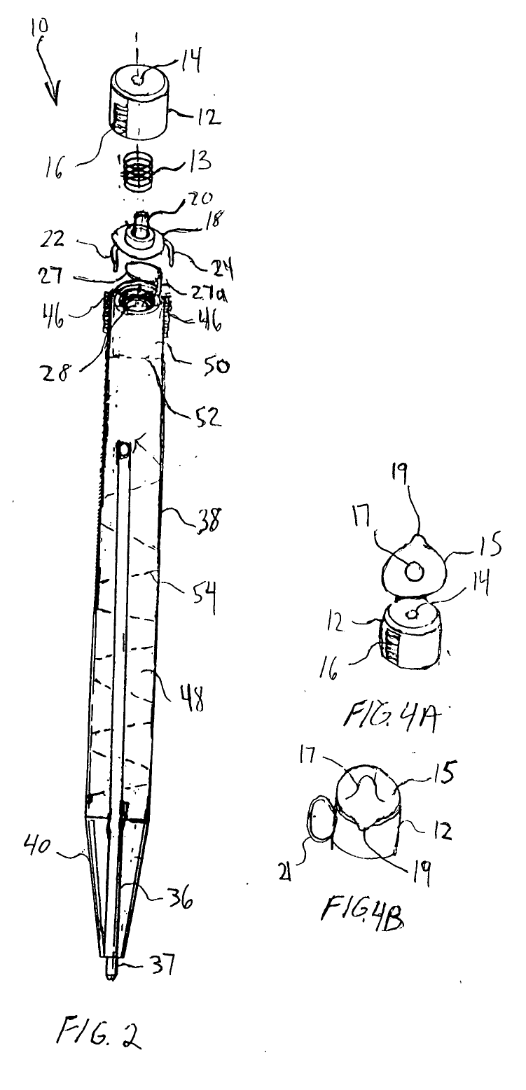

Referring to FIGS. 1 and 2, where like numbers represent the same elements, there is shown an electrically heated writing instrument denoted 10, in accordance with a preferred embodiment of the present invention. The electrically heated writing instrument 10 includes an end cap 12 having an aperture 14 formed through the top center of the end cap 12. The end cap 12 further includes a plurality of threads 16 formed within the internal wall of the end cap 12 for removably attaching to a hollow barrel 38, as described below. It will be noted that the end cap 12 may be hingedly attached to, snapped on to, twisted on or otherwise coupled to the hollow barrel 38. The end cap 12 may be constructed of plastic, metal or a rubber material.

The writing instrument 10 further includes a bias member 13 and a switching means 18. The switching means 18 may include a mechanical switch or an electrical switch. The mechanical switch can include any mechanical means which provides a means of electrically coupling a heating member 54 to at least one power source 28. In a preferred embodiment, the switching means 18 includes an electrical switch. The electrical switch 18 may comprise a timer control, a toggle switch, a dip switch, a push button, a thermostat, a variable resistance on/off switch, a contact relay or an on/off potentiometer. In a preferred embodiment, the electrical switch 18 includes an on/off push button switch. The electrical switch 18 includes an operator member 20, a first switch contact 22 and a second switch contact 24.

The writing instrument 10 further includes at least one power source 28, a first polarity end plate 30 including a first contact arm 30a and a spring member 30b and a second polarity end plate 27 including a second contact arm 27a and an optional second spring member 27b. It will be noted that the first spring member 30b, and the first contact arm 30a is electrically or conductively coupled to said first polarity end plate 30 and that the second spring member 27b, and the second contact arm 27a is electrically or conductively coupled to said second polarity end plate 27.

The at least one power source 28 is a DC power source. The power source 28 may be a disposable or rechargeable battery which is available on the market. In one non-limiting example, the at least one power source 28 may include a watch or button style battery. Alternatively, the power source 28 may be specifically designed and engineered to provide a specific shape or size and/or a specific voltage and current.

The polarity end plates 27, 30, the contact arms 27a, 30a, and the spring members 27b, 30b, may comprise metal, nickel, wire, solder, gold, copper, or any other suitable electrically conductive material.

The electrically heated writing instrument 10 further includes a writing member 36 including a writing tip 37. In a preferred embodiment, the writing member includes a writing medium which comprises an ink cartridge. However, the heated writing instrument 10 may also include other forms of writing mediums, such as, chalk, lead, a felt marker, white-out, or a crayon material. In addition, the writing member 36 may include various shapes, designs or lengths and the writing medium may comprise one of a plurality of colors, and/or materials, including, but not limited to, a black, red, green, blue, yellow, purple, or orange color, and may include glitter or sparkle materials or combination thereof.

The electrically heated writing instrument 10 includes a hollow barrel 38 including a conical tip 40, a cover 42 and a receiving end 44. In a preferred embodiment, the hollow barrel 38 comprises a plastic, a hard rubber or metal material or any combination thereof and the hollow barrel 38 may comprise any shape, diameter or length. If the hollow barrel 38 is made of a metal material, provisions must be taken so as to properly isolate the first switch contact 22 from the second switch contact 24 so that the conductive metal material of the hollow barrel 38 does not provide an electrical short between the two switch contacts 22, 24. The conical tip 40 may be formed as one integral member with the hollow barrel 38 or the conical tip 40 may be fabricated separately and then removably attached to one end of said hollow barrel 38. The hollow barrel 38 may include a plurality of threads 46 externally formed on the receiving end 44 of said hollow barrel 38 for threadably receiving the end cap 12.

The hollow barrel 38 further includes a heating chamber 48 and a battery circuit housing 50. The heating chamber 48 and battery circuit housing 50 are separated by a separation wall 52. The separation wall 52 includes an aperture 53 for receiving the writing member 36. The heating chamber 48 includes a heating member 54. The heating member 54 comprises any one of an electrical resistance heating wire, an etched-foil heater, a flexible printed circuit heater, and a flexible carbon fiber heater for generating heat. The electrical resistance heating wire or wires may be solid, stranded or of a braided configuration. The heating member 54 is selected and designed to have the proper gauge, shape, length, type, thermal property and resistance so as to provide efficient, optimum heating.

The heating member 54 may be disposed within the hollow barrel 38 or the heating chamber 48, surroundably adhered to the interior surface of the hollow barrel 38 or heating chamber 48, or externally wrapped around the exterior surface of said hollow barrel 38 or heating chamber 48. In one non-limiting example, the heating chamber 48 or hollow barrel 38 may include a plurality of spiral grooves formed on or within the exterior surface of said heating chamber 48 or hollow barrel 38, wherein said heating member 54 is disposed within said plurality of grooves to be spirally wrapped around the exterior surface of the heating chamber 48 or hollow barrel 38. The heating member 54 may be insulated or not. The heating member 54 may be formed into sleeves for inserting into said hollow barrel 38, or molded, integrated or otherwise formed within the hollow barrel 38 or heating chamber 48 as a unitary piece.

In these or other arrangements, when installed about or within the hollow barrel 38 or heating chamber 48, the heating member 54 is constructed and positioned to heat or warm the finger tips of an individual and the writing member 36 included therein. The heating member 54 may be positioned such that it covers the entire length of the hollow barrel 38 or heating chamber 48 or a particular part or segment thereof.

The heating member 54 may be covered with or encapsulated within an insulating or semi-insulting material. A heat reflective material may be disposed between the heating member 54 and the writing member 36 so as to direct most of the heat towards the exterior surface of the hollow barrel 38 or heating chamber 48 away from the writing member 36, thereby limiting the amount of heat that will be generated or directed within the heating chamber 48 so as not to dry out the writing medium within said writing member 36.

Referring to FIGS. 1, 2, 3A and 3B, the battery circuit housing 50 includes a first receiver channel 56 including a first channel contact 55, a second receiver channel 58 including a second channel contact 57, and a third receiver channel 59 including a third channel contact 65. The battery circuit housing 50 is designed to have the proper size, shape, circumference and/or diameter so as to receive the receiver channels 56, 58, 59, the first polarity end plate 30, the at least one power source 28, the second polarity end plate 27, the electrical switch 18 and the bias member 13.

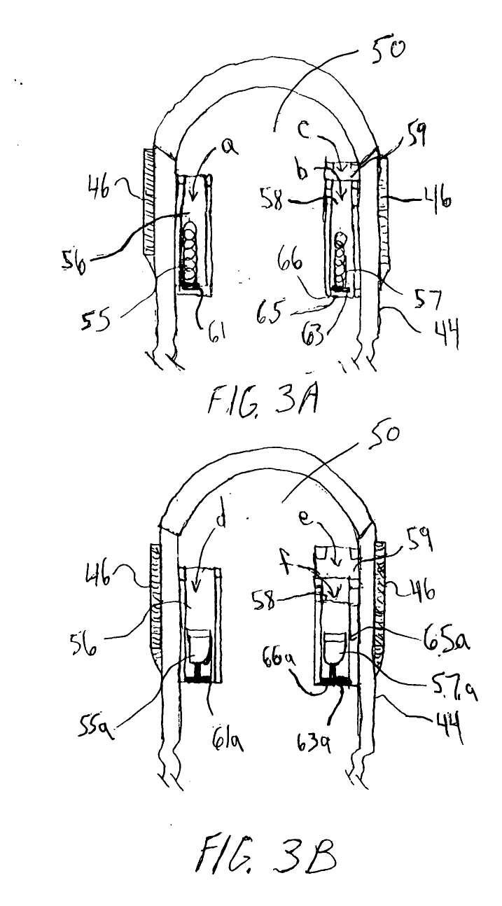

In one non-limiting example, FIG. 3A shows a battery circuit housing 50 including receiver channels 56, 58, 59. Each one of the receiver channels 56, 58 and 59 includes a corresponding channel contact comprising a spring contact 55, 57, 65, respectively, and a conductive base plate 61, 63 and 66. The first contact arm 30a of the first polarity end plate 30, is electrically coupled to base plate 61 and a first switch contact 22 is disposed in the area designated “a” in receiver channel 56. The first switch contact 22 is coupled to the base plate 61, via, the spring contact 55. The second contact arm 27b of the second polarity end plate 27 is disposed in the area designated “b” in receiver channel 58 and a first end of the heating member 54 is electrically coupled to base plate 63. The second arm 27b of the second polarity end plate 27 is coupled to the first end of the heating member 54, via, the spring contact 57. The second switch contact 24 of the electrical switch 18 is disposed in the designated area “c” in receiver channel 59 and the second end of the heating member 54 is electrically coupled to base plate 66. The second switch contact 24 is electrically coupled to the second end of the heating member, via, spring member 65.

The first contact arm 30a is electrically coupled to a first polarity of the at least one power source 28, via, the first polarity end plate 30 and the second contact arm 27a is electrically coupled to a second polarity of the at least one power source 28, via, the second polarity end plate 27. Therefore, the electrical switch 18 is electrically coupled to the heating member 54 and the at least one power source 28 for controllably supplying current to the heating member 54.

The channel contacts 55, 57, 65, may include any one of or a combination of connectors including resilient electrical connectors, male or female connectors, bias members, plug-in contacts, lugs, butt splices, printed circuit boards, solder joints, wire terminals, or spring contacts which may comprise metal, copper, solder, wire or other suitable conductive material.

In another non-limiting example, FIG. 3B shows a battery circuit housing 50 including receiver channels 56, 58, 59. Each one of the receiver channels 56, 58 and 59 includes a corresponding channel contact comprising a female connector 55a, 57a, 65a, and a conductive base plate 61a, 63a and 66a, respectively. The first contact arm 30a of the first polarity end plate 30, is electrically coupled to base plate 61a and a first switch contact 22 is disposed in the area designated “d” in receiver channel 56. The first switch contact 22 is coupled to the base plate 61a, via, the female connector 55a. The second contact arm 27b of the second polarity end plate 27 is disposed in the area designated “e” in receiver channel 59 and a first end of the heating member 54 is electrically coupled to base plate 65a. The second contact arm 27b of the second polarity end plate 27 is coupled to the first end of the heating member 54, via, the female connector 65a. The second switch contact 24 of the electrical switch 18 is disposed in the designated area “f” and the second end of the heating member 54 is electrically coupled to base plate 63a. The second switch contact 24 is electrically coupled to the second end of the heating member, via, the female connector 57a.

The first contact arm 30a is electrically coupled to a first polarity of the at least one power source 28, via, the first polarity end plate 30 and the second contact arm 27a is electrically coupled to a second polarity of the at least one power source 28, via, the second polarity end plate 27. Therefore, the electrical switch 18 is electrically coupled to the heating member 54 and the at least one power source 28 for controllably supplying current to the heating member 54.

The channel contacts 55a, 57a, 65a, may include any one of or a combination of connectors including resilient electrical connectors, male or female connectors, bias members, plug-in contacts, lugs, butt splices, printed circuit boards, solder joints, wire terminals, or spring contacts which may comprise metal, copper, solder, wire or other suitable conductive material.

It will be appreciated that other connecting means may be used and arranged within said receiver channels 56, 58, 59 for electrically connecting the electrical switch 18 to said at least one power source 28 and said heating member 54.

The receiver channels 56, 58, 59 are preferably fabricated from plastic but may include other suitable materials. The receiver channels 56, 58, 59 can comprise any suitable length, shape or diameter. The receiver channels 56, 58, 59 allows an individual to easily remove the electrical switch 18 and second polarity end plate 27 so as to easily replace the at least one power source 28.

In assembly and operation, the writing member 36 is inserted within the hollow barrel 38, via, the aperture 53, formed within the separation wall 52 so that the writing tip 37 of said writing member 36 extends out from the conical tip 40. The separation wall 52 may not include an aperture 53, and thus, the writing member 36 may be inserted within the hollow barrel 38 at the opposite end of the receiving end 44 and then the conical tip 40 removably attached to the hollow barrel 38. A spring member (not shown) may be included at one end of the writing member 36 so that as the writing tip 37 of the writing member 36 is always extending out from the conical tip 40.

The first polarity end plate 30 is disposed within the battery circuit housing 50 so as to rest on the surface of the separation wall 52. At least one power source 28 is disposed within the battery circuit housing 50 where a first polarity of said at least one power source 28 rests on said spring member 30b of said first polarity end plate 30. As noted above, the first contact arm 30a of the first polarity end plate 30 is electrically coupled to the first channel contact 55 or 55a.

A second polarity end plate 27 is disposed within the battery circuit housing 50 so as to rest on the surface of a second polarity of said at least one power source 28. As noted above, the second polarity end plate 27 may include a spring member 27b, wherein when inserted into the battery circuit housing 50, the spring member 27b is compressed against a second polarity of said at least one power source 28. The second contact arm is electrically coupled as configured and described above in relation to FIGS. 3A and 3B.

The electrical switch 18 is inserted within said battery circuit housing 50, such that the first switch contact 22 is disposed within the first receiver channel 56 thereby being electrically coupled to a first polarity of said at least one power source 28, via, the first polarity end plate 30 and first channel contact 55. The second switch contact 24 is disposed within the second receiver channel 58 so that the second switch contact 24 of the electrical switch 18 is electrically coupled to the first end of said heating member 54, via, the second channel contact 57. Thus, the electrical switch 18 is electrically coupled to the at least one power source 28 and the heating member 54, via, the channel contacts 55, 57, 65.

When the electrical switch 18 is inserted within the battery circuit housing 50, the spring member 30b of the first polarity end plate 30 pushes the at least one power source 28 upwards, against the second polarity end plate 27 and optionally, the spring member 27b of the second polarity end plate 27 pushes the at least one power source 28 downwards, against the first polarity end plate 30.

In addition, the end cap 12 is removably attached to the hollow barrel 38 such that the operator member 20 of the electrical switch 18 extends through the aperture 14 of the end cap 12. It will be noted that the aperture 14 may comprise any shape or size in order to accommodate the operator member 20 of the electrical switch 18. The end cap 12 forces the bias member 13 to push and/or compress the second polarity end plate 27 against a second polarity end of the at least one power source 28. Further, the bias member 13 secures the first switch contact 22 and the second switch contact 24 of the electrical switch 18 and the second contact arm 27a of the second polarity end plate 27 within the corresponding receiver channels 56, 58, 59, so that the first switch contact 22, the second switch contact 24 and the second contact arm 27a electrically engage or connect with the first channel contact 55, 55a the second channel contact 57, 57a and third channel contact 65, 65a.

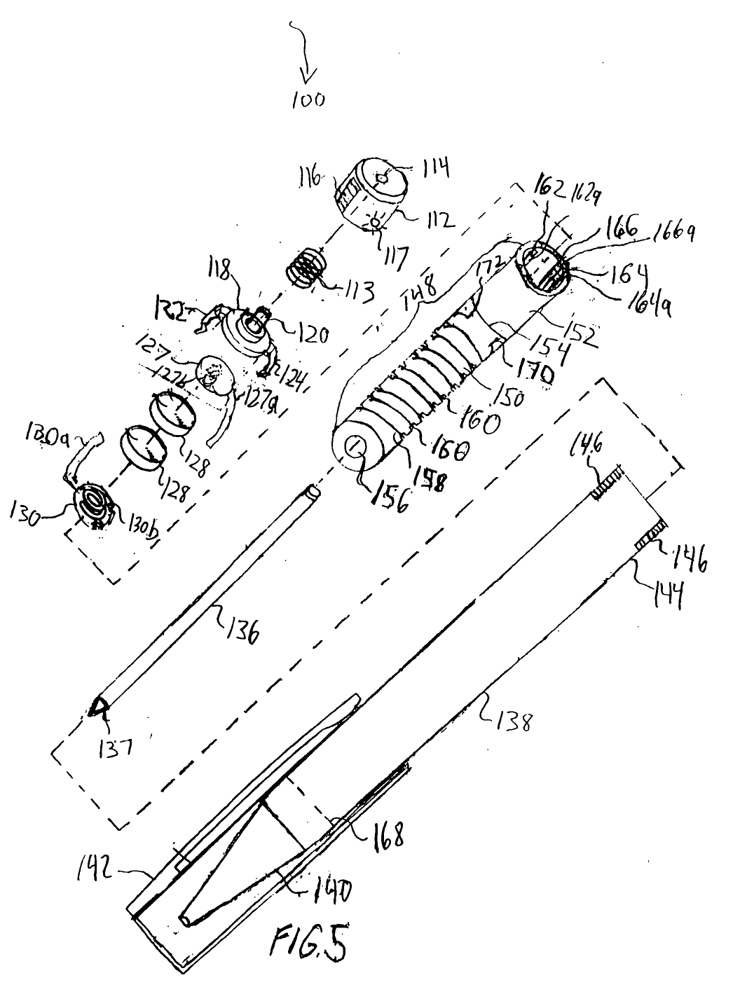

Referring to FIGS. 4A and 4B, there is shown an end cap 12 as noted above. The end cap 12 includes a protective cover 15 including an extending shield 17 formed on or within the surface of said protective cover 15. The extending shield 17 is positioned to receive and fit over the operator member 20 of the electrical switch 18 in order to prevent an individual from gaining access to the operator member 20 so as not to accidentally activate the electrical switch 18. The protective cover 15 also includes a lip 19 which allows a user to easily open the protective cover 15 when wanting to access the operator member 20 which is extending out from the aperture 14. The protective cover 15 may comprise plastic, rubber or any combination thereof. The end cap 12 may also include a ring 21 for attaching the writing instrument 10 to a strap, garment, necklace, bracelet or object. The ring 21 may comprise metal, hard rubber or a plastic material.

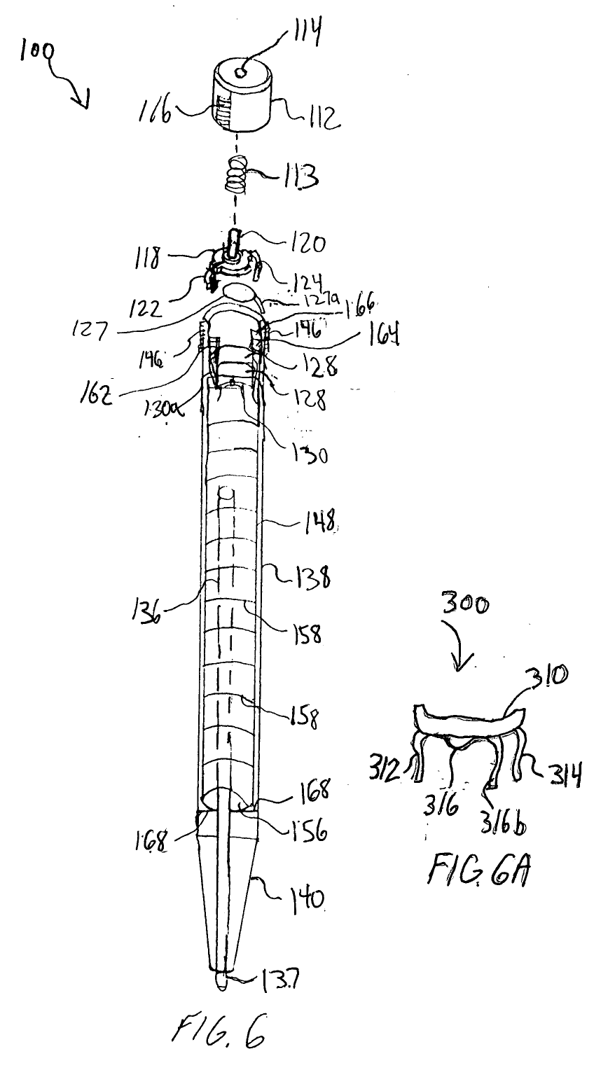

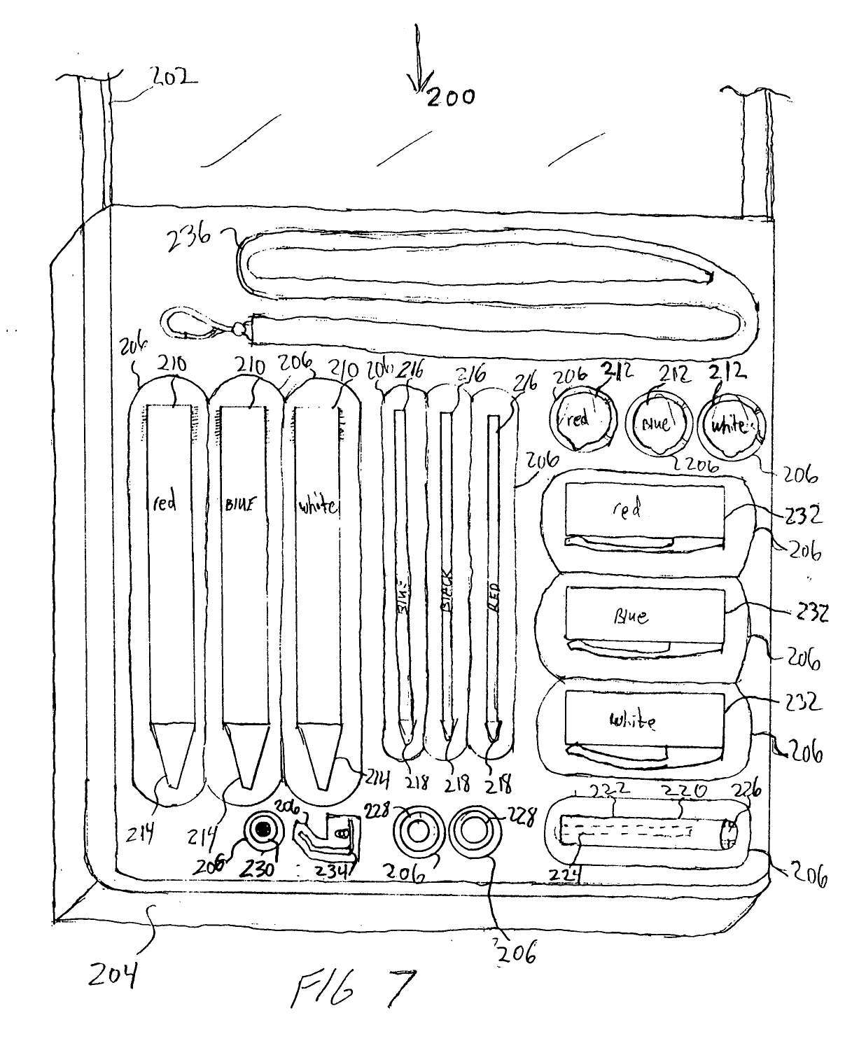

Referring now to FIGS. 5 and 6, there is shown an electrically heated writing instrument denoted 100, in accordance with an alternative embodiment of the present invention. The electrically heated writing instrument 100 includes an end cap 112 having an aperture 114 formed through the top center of the end cap 112. Although the end cap 112 shown includes a plurality of threads 116 formed within the internal wall of the end cap 112 for removably attaching to a hollow barrel 138, it will be noted that the end cap 112 can be hingedly attached to, snapped on to, twisted on or otherwise coupled to the hollow barrel 138. The end cap 112 may be constructed of plastic, metal or a rubber material.

The writing instrument 100 further includes a bias member 113 and a switching means 118 including a mechanical switch or an electrical switch. The mechanical switch can include any mechanical means which provides a means for controllably supplying a voltage and current, of a power source, to an element or component, such as, a heating member 154 as described below. In a preferred embodiment, the switching means 18 includes an electrical switch. The electrical switch 118 may include a timer control, a toggle switch, a dip switch, a push button, a thermostat, a variable resistance on/off switch, a contact relay or an on/off potentiometer. In a preferred embodiment, the electrical switch 118 includes an on/off push button switch. The electrical switch 118 includes an operator member 120, a first switch contact 122 and a second switch contact 124.

The writing instrument further includes at least one power source 128, a first polarity end plate 130 including a first contact arm 130a and a spring member 130b and a second polarity end plate 127 including a second contact arm 127a and an optional second spring member 127b. It will be noted that the first spring member 130b, and the first contact arm 130a are electrically or conductively coupled to said first polarity end plate 130 and that the second spring member 127b, and the second contact arm 127a are electrically or conductively coupled to said second polarity end plate 127.

The at least one power source 128 is a DC power source. The power source 128 may be a disposable or rechargeable battery which is available on the market. In one non-limiting example, the at least one power source 128 may include a watch or button style battery. Alternatively, the power source 128 may be specifically designed and engineered to provide a specific shape or size and/or a specific voltage and current.

The polarity end plates 127, 130, the contact arms 127a, 130a, and the spring members 127b, 130b, may comprise metal, nickel, wire, solder, gold, copper, or any other suitable electrically conductive material.

The electrically heated writing instrument 100 further includes a writing member 136 including a writing tip 137. In a preferred embodiment, the writing member 136 includes a writing medium which comprises an ink cartridge. However, the writing member 136 may also include other forms of writing mediums, such as, chalk, lead, a felt marker, or a crayon material. In addition, the writing member 136 may include various shapes, designs or lengths and the writing medium may comprise one of a plurality of colors and/or materials, including, but not limited to, a black, red, green, blue, yellow, purple, or orange color, and may include glitter or sparkle materials or combination thereof.

The electrically heated writing instrument 100 includes a hollow barrel 138 including a conical tip 140, a cover 142 and a receiving end 144. In a preferred embodiment, the hollow barrel 138 comprises a plastic, rubber or metal material or any combination thereof. If the hollow barrel 138 is made of a metal material, provisions must be taken so as to properly isolate the first switch contact 122 from the second switch contact 124 so that the conductive metal material of the hollow barrel 138 does not provide an electrical short between the two contact members 122, 124. The conical tip 140 may be formed as one integral member with the hollow barrel 138 or the conical tip 140 may be fabricated separately and removably attached to receiving end 144 of the hollow barrel 138. The hollow barrel 138 may include a plurality of threads 146 externally formed on the receiving end 144 of said hollow barrel 138 for threadably receiving the end cap 112.

The electrically heated writing instrument 100 further includes a heating cartridge 148. The heating cartridge 148 includes a heating chamber 150 and a battery circuit housing 152. The heating chamber 148 and battery circuit housing 152 are separated by a separation wall 154. The heating chamber 148 includes an elongated aperture 156 for receiving one end of the writing member 136.

The heating chamber 148 includes a heating member 158. The heating member 158 comprises any one of an electrical resistance heating wire, an etched-foil heater, a flexible printed circuit heater, and a flexible carbon fiber heater for generating heat. The electrical resistance heating wire or wires may be solid, stranded or of a braided configuration. The heating member 158 is selected and designed to have the proper gauge, shape, length, type, thermal property and resistance so as to provide efficient, optimum heating.

The heating member 158 may be disposed within the heating chamber 150, surroundably adhered to the interior surface of the heating chamber 150, or externally wrapped around the exterior surface of said heating chamber 150.

In one non-limiting example, the heating chamber 150 includes a plurality of spiral grooves 160 formed on or within the exterior surface of said heating chamber 150, wherein said heating member 158 is disposed within said plurality of grooves 160 to be spirally wrapped around the exterior surface of the heating chamber 150. The heating member 158 may be insulated or not. The heating member 158 may be formed into sleeves for inserting into said heating chamber 150, or the heating member 158 may be molded, integrated or otherwise formed into the heating chamber 150 as a unitary piece.

In these or other arrangements, when installed about or within the heating chamber 150, the heating member 158 is constructed and positioned to heat or warm the finger tips of an individual and the writing member 136. The heating member 158 may be positioned such that it covers the entire length of the heating chamber 150 or a particular part or segment thereof.

The heating member 158 may be covered with or encapsulated within an insulating or semi-insulting material, or a heat reflective material may be disposed between the heating member 158 and the writing member 136 so as to direct most of the heat towards the exterior surface of the hollow barrel 138 or heating chamber 150 away from the writing member 136, thereby limiting the amount of heat that will be generated or directed within the heating chamber 150 so as not to dry out the writing medium within said writing member 136. In addition, the heating chamber 150 itself may include heat-insulating properties to direct most of the generated heat away from the writing member 136. The hollow barrel 138 further includes a stopping member 168 for preventing the heating cartridge 148 from sliding out of the hollow barrel 138.

It will be appreciated that the heating cartridge 148 may comprise any suitable length. For example, the heating cartridge 148 may be slightly shorter then the length of the hollow barrel 138, allowing enough space for the battery circuit housing 152 or the heating cartridge 148 may be much shorter then the hollow barrel 138 providing more space for the battery circuit housing 152. As noted above, both the heating chamber 150 and the battery circuit housing 152 may be of any suitable length, one may be shorter then the other or they may comprise the same length, however, the length of both the heating chamber 150 and the battery circuit housing 152 combined, should not exceed the length of the hollow barrel 138.

The battery circuit housing 152 includes a first receiver channel 162 including a first channel contact 162a, a second receiver channel 164 including a second channel contact 164a, and a third receiver channel 166 including a third channel contact 166a. The battery circuit housing 152 is designed to have the proper size, shape, circumference and/or diameter so as to include therein the receiver channels 162, 164, 166, the first polarity end plate 130, the at least one power source 128, the second polarity end plate 127, the electrical switch 118 and the bias member 113.

The channel contacts 162a, 164a, 166a may include any one of or a combination of connectors including resilient electrical connectors, male or female connectors, bias members, plug-in contacts, butt splices, printed circuit boards, solder joints, wire terminals, or spring contacts which may comprise metal, copper, solder, wire or other suitable conductive material.

It will be appreciated that other connecting means may be used and arranged within said contact receiver channels 162, 164, and 166 for electrically connecting the electrical switch 118 to said at least one power source 128 and said heating member 158. Although there are non-limiting examples described above in reference to FIGS. 3A and 3B above, the electrical configuration is described again herein below.

The first contact arm 130a of the first polarity end plate 130, is electrically coupled to the first switch contact 122, via, the channel contact 162a. The second contact arm 127b of the second polarity end plate 127 and a first end of the heating member 158 is electrically coupled to channel contact 164a. The second switch contact 124 of the electrical switch 118 and the second end of the heating member 158 is electrically coupled to channel contact 166a. The first contact arm 130a is electrically coupled to a first polarity of the at least one power source 128, via, the first polarity end plate 130 and the second contact arm 127a is electrically coupled to a second polarity of the at least one power source 128, via, the second polarity end plate 127. Therefore, the electrical switch 118 is electrically coupled to the heating member 158 and the at least one power source 128 for controllably supplying current to the heating member 158.

The end cap 112 may further comprise a low current light-emitting diode 117 for indicating whether the at least one power source 128 is low in voltage. The light-emitting diode 117 may also be used for indicating whether the heating member 158 is activated or not.

Referring to FIG. 6A, there is shown an adaptor denoted at 300. The adaptor 300 includes a receptacle 310. The receptacle 310 is designed to receive a variety of electrical switches. The receptacle may include a printed circuit board, solder joints, male/female connectors or any suitable conductive material for electrically coupling to the contacts of an electrical switch that is disposed within the receptacle 310. The adaptor 300 further includes a first leg contact 312, and a second leg contact 314 which are electrically coupled to the contacts of an electrical switch, via, the printed circuit board, solder joints or male/female connectors. The adaptor 300 also includes a second polarity end plate 316 including an adaptor contact arm 316b. The second polarity end plate 316 is formed as an integral part of the adaptor 300. Thus, the adaptor 300 can receive a variety of electrical switches that can be electrically coupled to the leg contacts, 312, 314 and the adaptor 300 also includes a second polarity end plate 316 which is made as part of the adaptor 300. Each one of the leg contacts 312, 314, and the adaptor contact arm 316b are inserted into the corresponding receiver channels 162, 164 and 166 for electrically coupling an electrical switch to the at least one power source 128 and the heating member 158.

In assembly and operation, a first end of the heating member 158 is electrically coupled to the second channel contact 164a and a second end of the heating member 158 is electrically coupled to the third channel contact 166a.

The writing member 136 is inserted within the hollow barrel 138 so that the writing tip 137 of said writing member 136 extends out from the conical tip 140. The writing member 136 may also be inserted within the hollow barrel 138 at the opposite end of the receiving end 144 and then the conical tip 140 removably attached to the hollow barrel 138.

The heating cartridge 148 is disposed within the hollow barrel 138 so that a portion of the writing member 136 is inserted within the elongated aperture 156 of the heating cartridge 148 or heating chamber 150. As noted above, the heating cartridge 148 may be designed such that the heating chamber 150 covers all or a selected portion of said writing member 136. The heating cartridge 148 rests on the stopping member 168 so as not to slide out of the hollow barrel 138 in the event the conical tip 140 is removed from the hollow barrel 138.

The first polarity end plate 130 is disposed within the battery circuit housing 152 so as to rest on the surface of the separation wall 154. At least one power source 128 is disposed within the battery circuit housing 152 where a first polarity of said at least one power source 128 rests on said spring member 130b of said first polarity end plate 130. The first contact arm 130a of the first polarity end plate 130 is electrically coupled to the first channel contact 162a.

A second polarity end plate 127 is disposed within the battery circuit housing 152 so as to rest on the surface of a second polarity of said at least one power source 128. As noted above, the second polarity end plate 127 may include a spring member 127b, so that when the second polarity end plate 127 is inserted into the battery circuit housing 152, the spring member 127b is compressed against a second polarity of said at least one power source 128. When inserted, the second contact arm 127a of the second polarity end plate 127 is disposed within the third receiver channel 166 such that the second contact arm 127a is electrically coupled to the third channel contact 166a.

The electrical switch 118 is inserted within said battery circuit housing 152, such that the first switch contact 122 is disposed within the first receiver channel 162 so that the first switch contact 122 is electrically coupled to a first polarity of said at least one power source 128, via, the first channel contact 162a. The second switch contact 124 is disposed within the second receiver channel 164 so that the second switch contact 124 of the electrical switch 118 is electrically coupled to the first end of said heating member 158, via, the second channel contact 164a. Thus, the electrical switch 118 is electrically coupled to the at least one power source 128 and the heating member 158, via, the channel contacts 162a, 164a, and 166a.

When the electrical switch 118 is inserted within the battery circuit housing 152, the spring member 130b of the first polarity end plate 130 pushes the at least one power source 128 upwards, against the second polarity end plate 127 and optionally, the spring member 127b of the second polarity end plate 127 pushes the at least one power source 128 downwards, against the first polarity end plate 130.

The end cap 112 is removably attached to the hollow barrel 138 such that the operator member 120 of the electrical switch 118 extends through the aperture 114 of the end cap 112. It will be noted that the aperture 114 may comprise any shape or size in order to accommodate the operator member 120 of the electrical switch 118. The end cap 112 forces the bias member 113 to push and/or compress the second polarity end plate 127 against a second polarity end of the at least one power source 128. Further, the bias member 113 secures the first switch contact 122 and the second switch contact 124 of the electrical switch 118 and the second contact arm 127a of the second polarity end plate 127 within the corresponding receiver channels 162, 164, 166, so that the first switch contact 122, the second switch contact 124 and the second contact arm 127a electrically engage or connect with the first channel contact 162a, the second channel contact 164a and third channel contact 166a.

Referring to FIG. 7, there is shown an electrically heated writing instrument kit generally denoted 200, in accordance with an alternative embodiment of the present invention. The writing instrument kit 200 includes a cover 202 and a base 204. The cover 202 may be transparent, comprise one of a plurality of colors, or be opaque and may be formed as a sleeve, snap-on or to the base, be hinged to the base, be zipped to the base or any combination thereof. The cover 202 and base 204 may comprise plastic, hard rubber, vinyl, metal, thermoplastic, foam, or glass. It should be noted that other packaging means could be used to include the accessories listed below. For a non-limiting example, the instrument kit 200 may be packaged as a bubble pack, or encased within heat shrink material.

The base 204 includes a plurality of receptacles 206 for correspondingly receiving a plurality of hollow barrels 210 comprising one of a plurality of colors, a plurality of end caps 212 comprising one of plurality of colors, each one of said plurality of hollow barrels including a conical end 214, a plurality of writing members 216, each one of said plurality of writing members including a writing medium, said writing medium comprising one of a plurality of colors, each one of said plurality of writing members including a writing tip 218. The kit 200 further includes a heating cartridge 220 including a heating chamber 222 having an aperture 224 for receiving one of said plurality of writing members 216, and a battery circuit housing 226 including an electrical connecting means 227, said battery housing designed for receiving at least one power source 228, a second polarity end plate 234 and a switch means 230.

The writing instrument kit 200 further includes a plurality of covers 232 comprising one of a plurality of colors and a strap 236. The strap 236 may comprise any color or length and any suitable material, such as, rubber, leather, fabric, plastic or any combination thereof and may comprise any logo. It will be appreciated that the writing instrument kit 200 may also include an adaptor 300 as described in reference to FIG. 6A above, thereby eliminating the need for placing a second polarity end plate 234 within the kit 200 assembly.

The electrically heated writing instrument 100 is assembled from the electrically heated writing instrument kit 200, as described above in relation to FIGS. 3A, 3B, 4A, 4B, 5 and 6.

The electrically heated writing instrument kit 200 allows an individual to assemble an electrically heated writing instrument 100 using a variety of colors. In one non-limiting example, one may select a red end cap 212, a white hollow barrel 210, a blue cover 232 and a writing medium 216 having a black medium. In another non-limiting example, one may select a blue end cap 212, a blue hollow barrel 210 and a blue cover 232.

It will be appreciated that reference made to a plurality of colors and to the examples given herein in relation to selecting various combinations of colors is not limited to any particular color(s) or to any particular combination of colors. The description made to a plurality of colors includes any conceivable color wherein any conceivable combination of those colors can be used when assembling a writing instrument. The inclusion of the colors, red, blue, white, and black in FIG. 7 is for illustration purposes only and is not limiting to include only those colors recited.

It will be noted that the electrically heated writing instrument may include a variety or ergonomic features, designs, lengths, colors or shapes. Some ergonomic features may include rubber or gel elements or material disposed about the writing instrument.

In addition, the writing instrument may further include a venting means for venting heat out from the instrument. In a non-limiting example, the venting means may include one or more apertures or slots disposed about the hollow barrel of the instrument where the one or more apertures or slots can be covered by a moveable member.

Accordingly, there is disclosed an electrically heated writing instrument which provides the advantages of warming the finger tips of a user when holding and writing with the writing instrument and also warming the writing medium thereby making easier to write with when both the user and the writing instrument have been exposed to cold temperatures. The electrically heated writing instrument, as disclosed above, provides a compact, integral writing instrument, which can be manufactured at a low cost and which allows for easy repair or replacement of parts. In addition, there is disclosed an electrically heated writing instrument kit, which allows an individual to interchange various components, where each individual component comprises one of a plurality of colors.

While the invention has been shown and described in exemplary forms, it will be appreciated to those skilled in the art that many modifications, additions, and deletions can be made therein without departing from the spirit and scope of the invention as set forth in the following claims.

What is claimed is:

1. An electrically heated writing instrument comprising:
a hollow barrel including a conical end, and a battery circuit housing, said battery circuit housing including an electrical connecting means and at least one battery;
a writing member including a writing tip, said writing member being disposed within said hollow barrel so that said writing tip extends outward from said conical end of said hollow barrel;
a heating member disposed within or about said hollow barrel;
a switching means coupled to said at least one battery and said heating member for controllably supplying power to said heating member; and
an end cap removably attached to said hollow barrel.

2. The writing instrument of claim 1, wherein said electrical connecting means includes a first receiver channel including a first channel contact, a second receiver channel including a second channel contact, a third receiver channel including a third channel contact, a first polarity end plate including a first contact arm, and a second polarity end plate including a second contact arm.

3. The writing instrument in claim 2, wherein said writing member includes any one of an ink cartridge, lead, chalk, whiteout, felt marker or crayon.

4. The writing instrument in claim 3, wherein said heating member is arranged in any one of being surroundably attached to an inner surface of said hollow barrel, being surroundably attached to the exterior surface of said hollow barrel, being formed within a sleeve, said sleeve being inserted within said hollow barrel, or being molded or integrated within said hollow barrel.

5. The writing instrument of claim 4, wherein said heating member includes any one of electrical resistance heating wire, a flexible etched foil heater, heating tape, a flexible printed circuit heater or a carbon fiber heater.

6. The writing instrument of claim 5, wherein said writing instrument further includes heat reflective material disposed between said heating member and said writing member for directing most of said heat away from said writing member.

7. The writing instrument of claim 5, wherein said switching means includes a mechanical switch or an electrical switch.

8. The writing instrument of claim 7, wherein said electrical switch includes any one of an on/off push button, a toggle switch, a dip switch, a variable resistance on/off switch, a thermostat, a timer control, a potentiometer, or a contact relay, said electrical switch including at least a first switch contact and a second switch contact.

9. The writing instrument of claim 8, wherein said first polarity end plate is electrically coupled to a first polarity of said at least one battery, said first contact arm and said first switch contact being electrically coupled to said first channel contact.

10. The writing instrument of claim 9, wherein said second polarity end plate is electrically coupled to a second polarity of said at least one battery, said second contact arm and a first end of said heating member being electrically coupled to said second channel contact.

11. The writing instrument of claim 10, wherein said second switch contact and a second end of said heating member are electrically coupled to said third channel contact.

12. The writing instrument of claim 11, wherein said end cap includes a bias member for securely holding said electrical switch, said second polarity end plate and said at least one battery within said battery circuit housing.

13. (canceled)

14. (canceled)

15. The writing instrument of claim 12, wherein said first channel contact, said second channel contact and said third channel contact include any one of a bias member, a male or female connector, a plug-in connector, a solder connector, a printed circuit board, a resilient contact member, lugs, a butt splice, or a spring contact.

16. The writing instrument of claim 1, further including an adaptor including a receptacle for receiving a switching means and at least three leg contacts, each one of said leg contacts being disposed within a corresponding receiver channel within said battery circuit housing for electrically connecting said switching means to said at least one battery and said heating member.

17. (canceled)

18. An electrically heated writing instrument comprising:
a hollow barrel including a conical end;
a writing member including a writing tip, said writing member being disposed within said hollow barrel so that said writing tip extends outward from said conical end of said hollow barrel;
a heating cartridge including a heating chamber having an aperture for receiving said writing member, a battery circuit housing including at least one battery, and an electrical connecting means, said heating cartridge being disposed within said hollow barrel wherein one end of said writing member enters the aperture of said heating cartridge;
a heating member affixed within or about said heating chamber;
a switching means electrically coupled to said at least one battery and said heating member for controllably supplying power to said heating member; and
an end cap removably attached to said hollow barrel.

19. The writing instrument of claim 18, wherein said electrical connecting means includes a first receiver channel including a first channel contact, a second receiver channel including a second channel contact, a third receiver channel including a third channel contact, a first polarity end plate including a first contact arm, and a second polarity end plate including a second contact arm.

20. The writing instrument in claim 19, wherein said writing member includes any one of an ink cartridge, lead, chalk, felt marker, whiteout or crayon.

21. The writing instrument in claim 20, wherein said heating member is arranged in any one of being surroundably attached to an inner surface of said heating chamber, being surroundably attached to the exterior surface of said heating chamber, being formed within a sleeve, said sleeve being inserted within said heating chamber, or being molded or integrated within said heating chamber.

22. The writing instrument of claim 21, wherein said heating member includes any one of electrical resistance heating wire, a flexible etched foil heater, heating tape, a flexible printed circuit heater or a carbon fiber heater.

23. The writing instrument of claim 22, wherein said heating chamber includes insulating material disposed between said heating member and said writing member for directing most of said heat away from said writing member.

24. The writing instrument of claim 23, wherein said switching means includes a mechanical switch or an electrical switch.

25. The writing instrument of claim 24, wherein said electrical switch includes any one of an on/off push button, a toggle switch, a dip switch, a variable resistance on/off switch, a thermostat, a timer control, a potentiometer, or a contact relay, said electrical switch including at least a first switch contact and at least a second switch contact.

26. The writing instrument of claim 25, wherein said first polarity end plate is electrically coupled to a first polarity of said at least one battery, said first contact arm and said first switch contact are electrically coupled to said first channel contact.

27. The writing instrument of claim 26, wherein said second polarity end plate is electrically coupled to a second polarity of said at least one battery, said second contact arm and a first end of said heating member being electrically coupled to said second channel contact.

28. The writing instrument of claim 27, wherein said second switch contact and a second end of said heating member are electrically coupled to said third channel contact.

29. The writing instrument of claim 28, wherein said end cap includes a bias member for securely holding said second polarity end plate, said electrical switch and said at least one battery within said battery circuit housing.

30. (canceled)

31. (canceled)

32. The writing instrument of claim 29, wherein said first channel contact, said second channel contact and said third channel contact include any one of a bias member, a male or female connector, a plug-in connector, a solder connector, a printed circuit board, a resilient contact member, a butt splice, or a spring contact.

33. (canceled)

34. (canceled)

35. (canceled)

36. An electrically heated writing instrument kit comprising:
a plurality of hollow barrels comprising one of a plurality of colors, and a plurality of end caps comprising one of plurality of colors, each one of said plurality of hollow barrels including a conical end;
a plurality of writing members, each one of said plurality of writing members including a writing medium, said writing medium comprising one of a plurality of colors, each one of said plurality of writing members including a writing tip, one of said plurality of writing members being disposed within a corresponding one of said plurality of hollow barrels so that the writing tip of the writing members extends outward from the conical end of of the hollow barrels;
a heating cartridge including a heating chamber having an aperture for receiving one of said plurality of writing members, a battery circuit housing including at least one battery and an electrical connecting means, said heating cartridge being disposed within one of said plurality of hollow barrels wherein one end of said plurality of writing members enters the aperture of said heating cartridge;
a heating member affixed within or about said heating chamber;
a switching means electrically coupled to said at least one battery and said heating member for controllably supplying power to said heating member; and
one of said plurality of end caps removably attached to one of said plurality of hollow barrels.

37. The writing instrument of claim 36, wherein said electrical connecting means includes a first receiver channel including a first channel contact, a second receiver channel including a second channel contact, a third receiver channel including a third channel contact, a first polarity end plate including a first contact arm, and a second polarity end plate including a second contact arm.

38. The writing instrument in claim 37, wherein said writing member includes any one of an ink cartridge, lead, chalk, felt marker or crayon.

39. The writing instrument in claim 38, wherein said heating member is arranged in any one of being surroundably attached to an inner surface of said heating chamber, being surroundably attached to the exterior surface of said heating chamber, being formed within a sleeve, said sleeve being inserted within said heating chamber, or being molded or integrated within said heating chamber.

40. The writing instrument of claim 39, wherein said heating member includes any one of electrical resistance heating wire, a flexible etched foil heater, heating tape, a flexible printed circuit heater or a carbon fiber heater.

41. The writing instrument of claim 40, wherein said switching means includes a mechanical switch or an electrical switch.

42. The writing instrument of claim 41, wherein said electrical switch includes any one of an on/off push button, a toggle switch, a dip switch, a variable resistance on/off switch, a thermostat, a timer control, a potentiometer, or a contact relay, said electrical switch including at least a first switch contact and at least a second switch contact.

43. The writing instrument of claim 42, wherein said first polarity end plate is electrically coupled to a first polarity of said at least one battery, said first contact arm and said first switch contact are electrically coupled to said first channel contact.

44. The writing instrument of claim 43, wherein said second polarity end plate is electrically coupled to a second polarity of said at least one battery, said second contact arm and a first end of said heating member being electrically coupled to said second channel contact.

45. The writing instrument of claim 44, wherein said second switch contact and a second end of said heating member are electrically coupled to said third channel contact.

46. The writing instrument of claim 45, wherein said end cap includes a bias member for securing said second polarity end plate, said electrical switch and said at least one battery within said battery circuit housing.

47. The writing instrument of claim 46, wherein each one of said plurality of end caps includes a protective cover including an extending shield member and a ring for coupling said writing instrument to a necklace, chain, bracelet, garment, or strap.

48. The writing instrument of claim 47, wherein said first channel contact, said second channel contact and said third channel contact include any one of a bias member, a male or female connector, a plug-in connector, a solder connector, a printed circuit board, a resilient contact member, a butt splice, or a spring contact.

49. (canceled)

50. The writing instrument of claim 48 further including a plurality of pen covers comprising one of a plurality of colors, each one of said plurality of pen covers being removably attached to a corresponding conical tip of a hollow barrel for covering the writing tip of a corresponding writing members.

51. The writing instrument of claim 50, further including a base and cover for covering said base, said base including a plurality of receptacles for receiving said plurality of hollow barrels comprising one of a plurality of colors, said plurality of end caps comprising one of a plurality of colors, said plurality of writing members including a writing medium comprising one of a plurality of colors, a plurality of pen covers comprising one of a plurality of colors, at least one power source, an electrical switch, a second polarity end cap, a heating cartridge and a strap.

52. The writing instrument of claim 18, wherein said heating member is affixed to the exterior surface of said heating cartridge said heating cartridge comprising heat reflective properties for completely shielding the writing member from heat.
